(19) United States
(12) Patent Application Publication
(10) Pub. No.: US 2025/0168490 A1
(43) Pub. Date: May 22, 2025

(54) IMAGING DEVICE, IMAGING CONTROL METHOD, AND PROGRAM

(71) Applicant: Sony Group Corporation, Tokyo (JP)

(72) Inventor: Mayuko Sato, Tokyo (JP)

(21) Appl. No.: 18/839,683

(22) PCT Filed: Mar. 9, 2023
(86) PCT No.: PCT/JP2023/009112

§ 371 Date: Aug. 19, 2024

(30) Foreign Application Priority Data
Mar. 30, 2022 (JP) 2022-056222

(51) Int. Cl. H04N 23/63; H04N 23/611; H04N 23/69

(52) U.S. Cl. CPC H04N 23/632; H04N 23/611; H04N 23/69; H04N 23/635

(57) ABSTRACT

An imaging device includes a display control unit that causes a display unit to continuously display a magnified image that is a magnified portion of a live view image based on an input image, after an imaging instruction during display of the magnified image by the display unit.

### TECHNICAL FIELD

The present technology relates to an imaging device, an imaging control method, and a program, and more particularly, to a technology to display live view images in magnified view.

### BACKGROUND ART

Image-capturing devices (cameras) that can display live view images in magnified view have been proposed. For example, in Patent Document 1, operation of a predetermined button switches display of live view images from 1×-magnification view to magnified view. This allows the user to check the focus position and the like on the images displayed in magnified view.

### CITATION LIST

### Patent Document

Patent Document 1: Japanese Patent Application Laid-Open No. 2017-11579

### SUMMARY OF THE INVENTION

### Problems to be Solved by the Invention

Meanwhile, when the shutter button is operated while a live view image is displayed in magnified view and imaging processing is performed, the above-described imaging device returns the display of live view images to 1×-magnification view. Consequently, even in a case where it is desired to continuously display a given subject in magnified view to continuously capture its images, for example, live view images are displayed at 1× magnification after each time of imaging processing.

Then, to allow a subject portion in live view images to be checked in magnified view, it is necessary to cause the user to perform an operation for magnified view after each time of imaging processing, forcing the user to perform a complicated operation.

Therefore, the present technology proposes a technology to allow the user to check live view images in magnified view without forcing a complicated operation.

### Solutions to Problems

An imaging device according to the present technology includes a display control unit that causes a display unit to continuously display a magnified image that is a magnified portion of a live view image based on an input image, after an imaging instruction during display of the magnified image by the display unit.

Consequently, even if imaging processing is performed during display of the magnified image, the imaging device can continue to display the magnified image, allowing the user to check the image portion of the live view image in magnified view.

### BRIEF DESCRIPTION OF DRAWINGS

FIG. 1 is a diagram showing an external appearance of an imaging device according to the present embodiment.

FIG. 2 is a diagram showing an external appearance of the imaging device according to the present embodiment.

FIG. 3 is a diagram showing an internal configuration of the imaging device.

FIG. 4 is a diagram showing recognizable parts of each subject category.

FIG. 5 is a diagram illustrating focus magnification display when a control target part has been recognized.

FIG. 6 is a diagram illustrating focus magnification display when a subject has not been recognized.

FIG. 7 is a diagram illustrating return to focus magnification.

FIG. 8 is a diagram illustrating switching of return to focus magnification between on and off.

FIG. 9 is a flowchart showing a flow of focus magnification display processing.

FIG. 10 is a diagram illustrating focus magnification display in a modification.

FIG. 11 is a diagram illustrating focus magnification display in a modification.

### MODE FOR CARRYING OUT THE INVENTION

Hereinafter, an embodiment will be described in the following order.
<1. Configuration of imaging device>
<2. Recognition processing>
<3. Focus magnification display processing>
<4. Modifications>
<5. Summary>
<6. Present technology>

Note that in the present technology, “images” include both still images and moving images. Furthermore, an “image” refers not only to that in a state of being displayed on a display unit, but also to image data in a state of not being displayed on the display unit.

A “subject” not only refers to an object to be captured by an imaging device 1, but also includes a subject image appearing in an image. Furthermore, “subjects” include not only humans but also various objects such as animals, birds, insects, cars, and trains, and further include portions (parts) thereof.

“Subject categories” indicate the categories or types of subjects and include humans, animals, birds, insects, cars, trains, etc. Furthermore, one subject category may include a plurality of (two or more) subject categories. Moreover, for example, as in the relationship between “birds” and “kingfishers”, a subject category (kingfishers) included in one subject category (birds) may be separately provided as a subject category.

“Imaging processing” refers to a series of processes of reading image signals from an imaging element in response to a predetermined operation such as a full press of the shutter button, performing predetermined signal processing thereon, and then recording the processed image signals on a recording medium as image data.

An “imaging instruction” refers to an operation to cause the imaging processing to be performed, such as a full press of the shutter button.

### 1. Configuration of Imaging Device

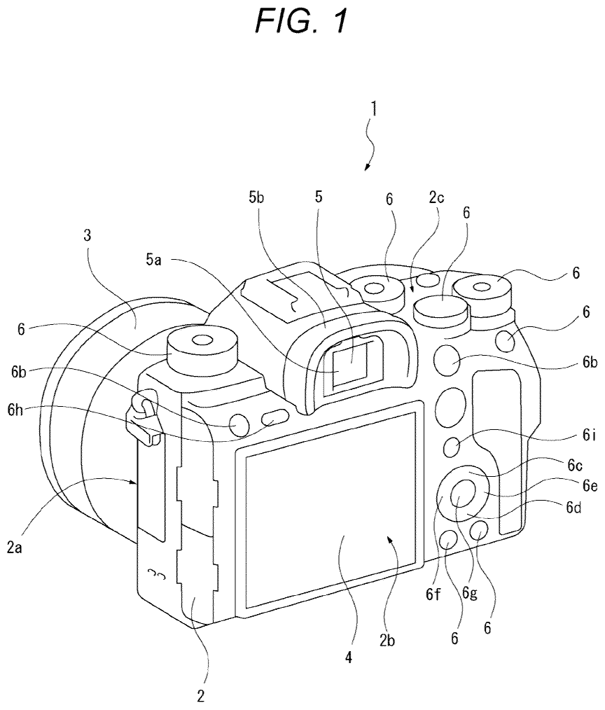

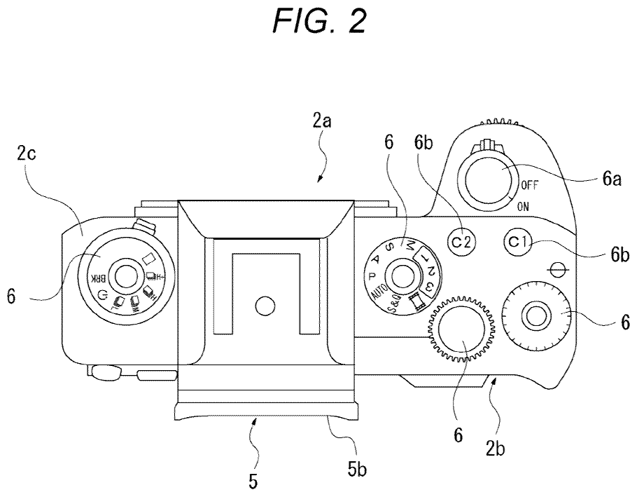

FIGS. 1 and 2 are diagrams showing an external appearance of the imaging device 1 according to the present embodiment. Note that in the following description, the subject side is referred to as the front, and the imaging operator side as the rear.

As shown in FIGS. 1 and 2, the imaging device 1 includes a camera housing 2 with necessary components disposed inside and outside thereof, and a lens barrel 3 that is detachable from the camera housing 2 and is attached to a front surface 2a. FIG. 2 shows the camera housing 2 with the lens barrel removed.

Note that the lens barrel 3 detachable as a so-called interchangeable lens is an example. A lens barrel that cannot be detached from the camera housing 2 may be used.

The camera housing 2 has a rear surface 2b on which a rear monitor 4 is disposed. The rear monitor 4 displays live view images, reproduced images of recorded images, and the like.

The rear monitor 4 includes, for example, a display device such as a liquid crystal display (LCD) or an organic electro-luminescence (EL) display.

The rear monitor 4 is rotatable with respect to the camera housing 2. For example, with an upper end portion of the rear monitor 4 as a turning shaft, a lower end portion of the rear monitor 4 can move rotationally rearward. Note that a right end portion or a left end portion of the rear monitor 4 may serve as a turning shaft. Moreover, the rear monitor 4 may be rotatable in directions around a plurality of axes.

The camera housing 2 has an upper surface 2c on which an electric viewfinder (EVF) 5 is disposed. The EVF 5 includes an EVF monitor 5a and a frame-shaped enclosure 5b projecting rearward around the upper side and the right and left sides of the EVE monitor 5a.

The EVF monitor 5a is formed using an LCD, an organic EL display, or the like. Note that instead of the EVE monitor 5a, an optical view finder (OVF) may be provided.

On the rear surface 2b and the upper surface 2c, various manipulation elements 6 are provided. Examples thereof include a shutter button (a release button), a reproduction menu activation button, a determination button, a cross key, a cancel button, a zoom key, and a slide key.

The manipulation elements 6 include those of various forms such as buttons, dials, and composite manipulation elements that can be pressed and rotated. The manipulation elements 6 of the various forms enable, for example, a shutter operation, a menu operation, a reproduction operation, a mode selection/switching operation, a focus operation, a zoom operation, and selection/setting of parameters such as a shutter speed and an F-number.

As the manipulation elements 6, for example, a shutter button 6a, a plurality of custom buttons 6b, an up button 6c, a down button 6d, a right button 6e, a left button 6f, a determination button 6g, a menu button 6h, and a function button 6i are provided.

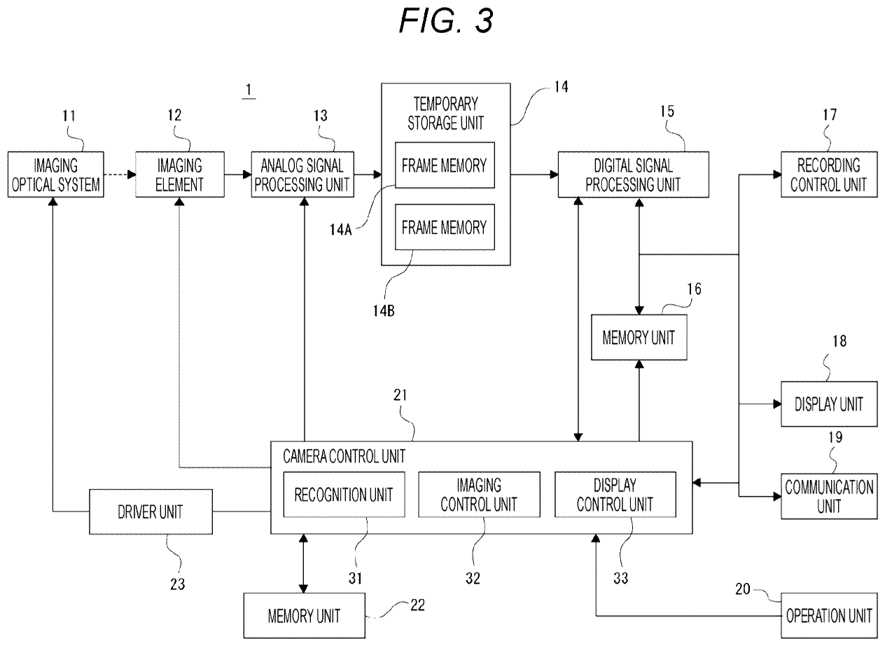

FIG. 3 is a diagram showing an internal configuration of the imaging device 1.

In the imaging device 1, light from a subject enters an imaging element 12 including, for example, a complementary metal oxide semiconductor (CMOS) sensor or a charge coupled device (CCD) sensor via an imaging optical system 11 and is photoelectrically converted by the imaging element 12, and an analog image signal is obtained from the imaging element 12.

The imaging optical system 11 is provided with various lenses such as a zoom lens, a focus lens, and a condenser lens, a diaphragm mechanism, a zoom lens drive mechanism, and a focus lens drive mechanism. A mechanical shutter is provided in some cases.

The imaging element 12 has, for example, a CMOS substrate on which a plurality of pixels each including a photodiode (a photogate), a transfer gate (a shutter transistor), a switching transistor (an address transistor), an amplification transistor, a reset transistor (a reset gate), and the like is formed in a two-dimensional array, and a vertical scanning circuit, a horizontal scanning circuit, and an image signal output circuit are formed.

The imaging element 12 may have either a primary color system or a complementary color system. Analog image signals obtained from the imaging element 12 are primary color signals of RGB colors or complementary color signals. Alternatively, the imaging element 12 may not include color filters, and analog image signals obtained from the imaging element 12 may be black and white image signals.

Analog image signals from the imaging element 12 are sampled and held for each color signal in an analog signal processing unit 13 configured as an integrated circuit (IC), adjusted in amplitude by automatic gain control (AGC), and converted into digital image signals by analog to digital (A/D) conversion.

The digital image signals (hereinafter, image data) from the analog signal processing unit 13 are input to a temporary storage unit 14.

Note that the imaging element 12 and the analog signal processing unit 13, or the imaging element 12, the analog signal processing unit 13, and the temporary storage unit 14 may be integrated. Furthermore, frame memories described below as the temporary storage unit 14 may be provided in a stacked imaging element.

The temporary storage unit 14 is provided with two frame memories 14A and 14B in this example.

Image data from the analog signal processing unit 13 is alternately stored in the frame memories 14A and 14B. That is, the temporary storage unit 14 stores two image frames captured consecutively. The image data stored in the temporary storage unit 14 is sequentially output to a digital signal processing unit 15 from the frame stored earlier. That is, the image data is sequentially output to the digital signal processing unit 15 alternately from the frame memories 14A and 14B according to the imaging order.

The provision of the frame memories 14A and 14B like this allows live view images to be continuously displayed without blackouts even during, for example, consecutive image capturing.

The digital signal processing unit 15 is configured as an image processor using, for example, a digital signal processor (DSP). The digital signal processing unit 15 performs various types of signal processing on the input image data. For example, as a camera process, the digital signal processing unit 15 performs preprocessing, synchronization processing, YC generation processing, and the like.

Further, the digital signal processing unit 15 performs, on the image data subjected to the various types of processing, for example, compression encoding for recording or communication, formatting, generation or addition of metadata, and the like as file formation processing, to generate a file for recording or communication. For example, as a still image file, an image file in a format such as JPEG, Tagged Image File Format (TIFF), or Graphics Interchange Format (GIF) is generated. Furthermore, an image file may be generated, for example, in MP4 format used for recording video and audio conforming to MPEG-4.

Note that an image file may be generated as raw image data.

Furthermore, the digital signal processing unit 15 performs resolution conversion processing on the image data (the input image) subjected to the various types of signal processing, to generate image data with a lower resolution to display a live view image, for example.

A memory unit 16 is a buffer memory for image data. The memory unit 16 includes, for example, a dynamic random access memory (D-RAM).

The image data processed by the digital signal processing unit 15 is temporarily stored in the memory unit 16 and is transferred to a recording control unit 17, a display unit 18, or a communication unit 19 at a predetermined timing.

The recording control unit 17 performs, for example, recording on and reproduction from a recording medium using a non-volatile memory. The recording control unit 17 performs, for example, processing of recording an image file such as moving image data or still image data on the recording medium.

The recording control unit 17 may take various actual forms. For example, the recording control unit 17 may include a flash memory built in the imaging device 1 and a write/read circuit thereof. Further, the recording control unit 17 may be in the form of a card recording/reproducing unit that performs recording/reproducing access to a recording medium removably fitted into the imaging device 1, for example, a memory card (such as a portable flash memory). Furthermore, the recording control unit 17 may be implemented as a hard disk drive (HDD) or the like as a form built in the imaging device 1.

The display unit 18 performs various types of display for the user and includes, for example, the rear monitor 4 and the EVF 5 disposed on the housing of the imaging device 1 as shown in FIG. 1.

The display unit 18 performs various types of display on a display screen on the basis of instructions from a camera control unit 21.

For example, the display unit 18 displays reproduced images of image data read from the recording medium in the recording control unit 17.

Further, the display unit 18 is provided with image data on captured images that have been converted in resolution for display by the digital signal processing unit 15, and performs display accordingly, that is, display of live view images.

Furthermore, the display unit 18 displays various operation menus, icons, messages, and the like, that is, a graphical user interface (GUI) on the screen on the basis of instructions from the camera control unit 21.

The communication unit 19 performs data communication and network communication with external devices in a wired or wireless manner.

For example, image data (a still image file or a moving image file) and metadata are transmitted or output to an external information processing device, display device, recording device, reproduction device, or the like.

Furthermore, the communication unit 19 can serve as a network communication unit to perform communication over various networks such as the Internet, a home network, and a local area network (LAN), to transmit and receive various types of data to and from a server, a terminal, and the like on the networks.

An operation unit 20 collectively represents input devices for the user to perform various operation inputs. Specifically, the operation unit 20 is the various manipulation elements 6 provided on the housing of the imaging device 1. Further, the manipulation elements 6 corresponding to the operation unit 20 also include, for example, a touch panel provided on the rear monitor 4 and a touch pad. Furthermore, the operation unit 20 may be configured as a unit to receive operation signals from a remote controller.

The operation unit 20 detects the user's operation and transmits a signal corresponding to the input operation to the camera control unit 21.

The camera control unit 21 includes a microcomputer (arithmetic processing device) with a central processing unit (CPU). The camera control unit 21 is an imaging control device that controls operation of the imaging device 1.

A memory unit 22 stores information and the like used for processing by the camera control unit 21. The memory unit 22 comprehensively represents, for example, read-only memory (ROM), random-access memory (RAM), flash memory, etc.

The memory unit 22 may be a memory region built in a microcomputer chip serving as the camera control unit 21 or may be configured using a separate memory chip. The camera control unit 21 controls the entire imaging device 1 by executing a program stored in the ROM, the flash memory, or the like of the memory unit 22.

For example, the camera control unit 21 performs instruction on the various types of signal processing in the digital signal processing unit 15, and control of an imaging operation, a recording operation, an operation to reproduce a recorded image file, and the like in response to the user's operations.

Further, the camera control unit 21 performs, as automatic exposure control, operation control of the diaphragm mechanism, control of the shutter speed of the imaging element 12, and AGC gain control in the analog signal processing unit 13.

Furthermore, the camera control unit 21 performs drive control of the focus lens and the zoom lens in response to autofocus control, a manual focus operation, a zoom operation, and the like.

Moreover, the camera control unit 21 controls the shutter speed, exposure timing, and the like in the imaging element 12.

The camera control unit 21 is provided with functions as a recognition unit 31, an imaging control unit 32, and a display control unit 33.

The recognition unit 31 performs processing to recognize a subject (control target part) on the basis of an input image.

The imaging control unit 32 performs processing to control each unit for imaging.

The display control unit 33 performs display control for images to be displayed on the display unit 18.

Note that the processing performed by the recognition unit 31, the imaging control unit 32, and the display control unit 33 will be described later in detail.

The RAM in the memory unit 22 is used to temporarily store data, a program, and the like as a work area during various types of data processing by the CPU of the camera control unit 21.

The ROM and the flash memory (non-volatile memory) in the memory unit 22 are used to store an operating system (OS) for the CPU to control each unit, application programs for various operations, firmware, various types of setting information, and the like.

The various types of setting information include communication setting information, setting information associated with imaging operation, setting information related to image processing, and the like. The setting information associated with imaging operation include an exposure setting, a shutter speed setting, a curtain speed setting of a mechanical shutter or an electronic shutter, a mode setting, and the like.

A driver unit 23 is provided, for example, with a motor driver for a zoom lens drive motor, a motor driver for a focus lens drive motor, a motor driver for a diaphragm mechanism motor, etc.

These motor drivers apply drive current to the corresponding drivers in response to instructions from the camera control unit 21 (the imaging control unit 32), causing them to move the focus lens and the zoom lens, and open and close diaphragm blades of the diaphragm mechanism, for example.

### 2. Recognition Processing

The camera control unit 21 performs recognition processing to recognize, from a live view image, a subject (a control target part) in a subject category that is a recognition target, of a plurality of subject categories. The subject recognized here is, for example, an object to be focused on in the autofocus control or an object to be tracked.

As the subject categories, for example, “Human”, “Animal”, “Bird”, “Insect”, “Car/Train” etc. are provided. “Animal” is a category for subjects that are mammals other than humans, including mammals that are pets such as dogs and cats and mammals that are wild animals. “Bird” is a category for subjects that are birds. “Car/Train” is a category for subjects that are cars (automobiles) or trains.

Furthermore, “Animal+Bird” is provided as a subject category. “Animal+Bird” includes the subject categories “Animal” and “Bird” described above. That is, “Animal+Bird” is a category for subjects that are mammals other than humans or birds. Thus, a subject category including a plurality of subject categories may be provided.

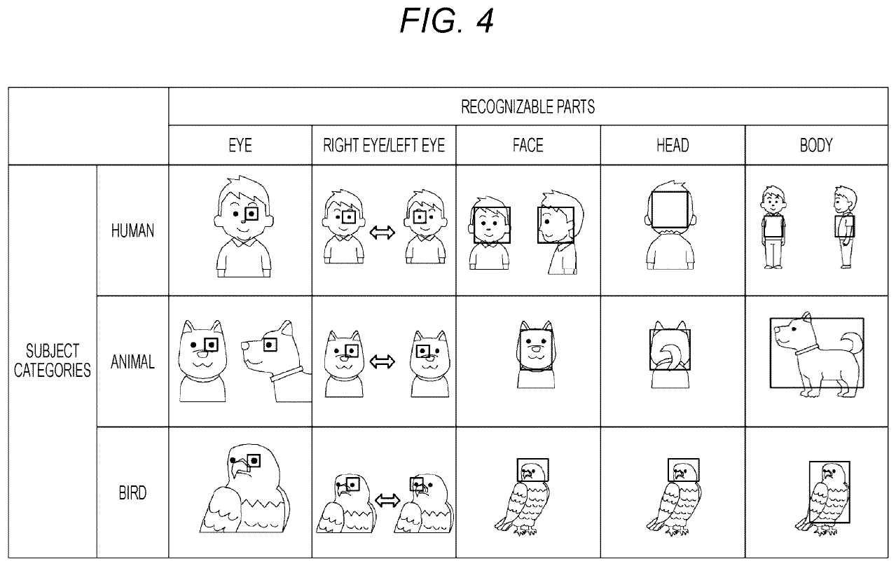

FIG. 4 is a diagram showing recognizable parts for each subject category. Note that FIG. 4 shows the recognizable parts enclosed in squares.

The imaging device 1 has determined in advance parts that can be recognized in the recognition processing (hereinafter, referred to as recognizable parts) for each subject category. As shown in FIG. 4, the subject categories “Human”, “Animal”, and “Bird” are provided, as recognizable parts, with “Eye”, “Face”, “Head”, and “Body”.

Note that the recognizable parts “Face” and “Head” are recognized as the same part. Hereinafter, these are collectively referred to as “Head”. However, the recognizable parts “Face” and “Head” may be recognized as different parts.

Furthermore, the subject categories “Human”, “Animal”, and “Bird” are provided, as recognizable parts, with “Right Eye” and “Left Eye”, which can be switched.

On the imaging device 1, a control target part is selected from among the recognizable parts and registered for each subject category. Here, the control target part indicates which part of the recognizable parts is to be controlled. “Eye”, “Head”, and “Body” as recognizable parts can be selected singly, and combinations of a plurality of recognizable parts, specifically, “Eye+Head” and “Auto (Eye+Head+Body)” can also be selected.

The control target part “Eye+Head” includes “Eye” and “Head” as control target parts, and “Eye” is prioritized over “Head”. Furthermore, the control target part “Auto” includes “Eye”, “Head”, and “Body” as control target parts, and “Eye” is prioritized over “Head”, and “Head” is prioritized over “Body”.

Note that the subject categories “Insect” and “Car/Train” are also provided with one or a plurality of recognizable parts. Here, description thereof is omitted.

The recognition unit 31 recognizes a subject and a recognizable part of the subject by the recognition processing for each subject category. The recognition processing is performed using an algorithm learned, for example, by deep learning such as a convolutional neural network (CNN).

In the imaging device 1, the algorithm learned in advance by deep learning or the like for each subject category is stored in the memory unit 22. Furthermore, on the imaging device 1, the user has selected in advance a subject category and a control target part.

The recognition unit 31 recognizes a subject and a recognizable part using the algorithm for the subject category selected in advance. Thus, the recognition processing allows the subject in the subject category that is the recognition target to be recognized, but does not allow subjects in subject categories that are not the recognition target to be recognized.

Then, for example, when the recognizable part set as the control target part is recognized in the image, the imaging control unit 32 performs the autofocus control to focus on the part.

### 3. Focus Magnification Display Processing

### [3-1. Example of Focus Magnification Display]

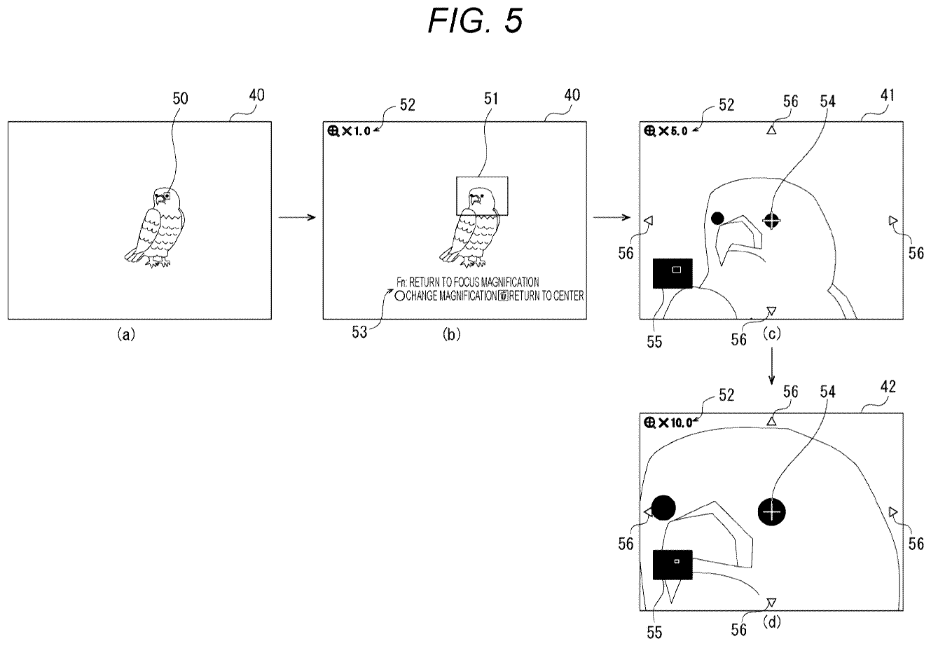

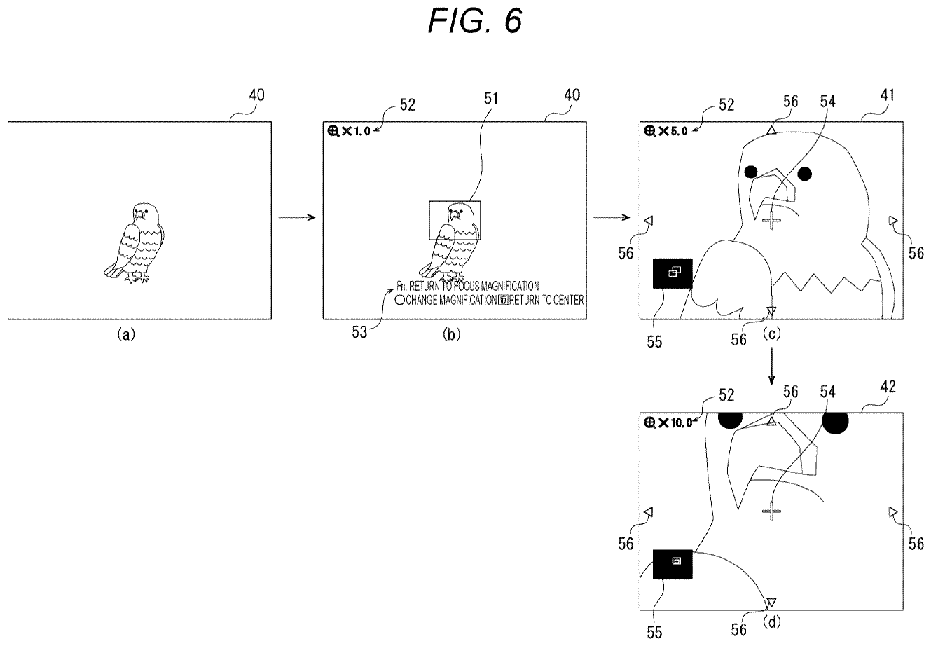

FIG. 5 is a diagram illustrating focus magnification display when a control target part has been recognized. FIG. 6 is a diagram illustrating focus magnification display when a subject has not been recognized.

When the user performs a predetermined operation while a live view image 40 based on an input image is displayed, the camera control unit 21 performs focus magnification display processing to display a portion of the live view image 40 in magnified view. For example, execution of the focus magnification display processing has been assigned in advance to one of the custom buttons 6b. Then, when the custom button 6b assigned the execution of the focus magnification display processing is operated while the live view image 40 is displayed, the camera control unit 21 performs the focus magnification display processing.

Here, in a case where a control target part has been recognized in the live view image 40 by the recognition unit 31 on the basis of the input image, as shown in FIG. 5(a), the display control unit 33 displays a recognition frame 50 around the recognized control target part in the live view image 40.

In this state, when the custom button 6b assigned the execution of the focus magnification display processing is operated, as shown in FIG. 5(b), the display control unit 33 displays a magnification frame 51 superimposed on the live view image 40 to provide a predetermined display magnification around the control target part. Note that the display control unit 33 may continuously display the recognition frame 50 when displaying the magnification frame 51.

In addition, the display control unit 33 displays a magnification scale icon 52 indicating the magnification scale of the image (the live view image 40, a first magnified image 41, or a second magnified image 42) displayed on the display unit 18 (the rear monitor 4). Here, a magnification of “1.0” is displayed as the magnification scale icon 52.

Moreover, the display control unit 33 displays an operation guide 53 indicating the types of manipulation elements 6 and operations to be performed by operating the manipulation elements 6.

Thereafter, when the custom button 6b assigned the execution of the focus magnification display processing or the determination button 6g is operated, as shown in FIG. 5(c), the display control unit 33 displays an image portion indicated by the magnification frame 51 in the live view image 40 in magnified view on the entire display unit 18. That is, the display control unit 33 causes the display unit 18 to display, as the first magnified image 41, the image portion magnified to a predetermined magnification (here, a magnification of 5.0) around the control target part in the live view image 40. That is, the display control unit 33 causes the display unit 18 to display, as the first magnified image 41, the image portion centered on the recognized control target part of the recognizable parts according to the subject category selected by the user. In other words, the display control unit 33 can be said to determine a region (a part) of the subject to be displayed as the first magnified image 41 according to the subject category.

In addition, the display control unit 33 displays the magnification scale icon 52, an image center mark 54, a magnified position display region 55, and move display icons 56 superimposed on the first magnified image 41.

The image center mark 54 is a mark indicating the center of the first magnified image 41 or the second magnified image 42, and is, for example, a cross mark.

The magnified position display region 55 is displayed at the lower left of the display unit 18. In the magnified position display region 55, a black portion indicates the imaging range of the live view image 40, and a white frame indicates the display range of the first magnified image 41 or the second magnified image 42. Thus, in the magnified position display region 55, the position of the first magnified image 41 or the second magnified image 42 in the live view image 40 is shown. Note that in the magnified position display region 55, the live view image 40 reduced in size may be displayed instead the black. Furthermore, the magnified position display region 55 may be changed in display position on the display unit 18 according to the position of the subject in the first magnified image 41 or the second magnified image 42. Specifically, the magnified position display region 55 may be displayed in a position not overlapping the subject in the first magnified image 41 or the second magnified image 42.

The move display icons 56 are displayed on the top, bottom, left, and right sides of the display unit 18, separately, and indicate that the image portion of the live view image 40 displayed as the first magnified image 41 or the second magnified image 42 can be moved.

Furthermore, when the custom button 6b assigned the execution of the focus magnification display processing or the determination button 6g is operated in a state where the first magnified image 41 shown in FIG. 5(c) is displayed on the display unit 18, as shown in FIG. 5(d), the display control unit 33 causes the display unit 18 to display the second magnified image 42 that is a portion of the live view image 40 further magnified (here, to a magnification of 10) with respect to the center of the first magnified image 41. In addition, the display control unit 33 displays the magnification scale icon 52, the image center mark 54, the magnified position display region 55, and the move display icons 56 superimposed on the second magnified image 42.

For example, when the shutter button 6a is pressed halfway after the first magnified image 41 or the second magnified image 42 is displayed on the display unit 18 as described above, the imaging control unit 32 controls each unit to focus on the subject corresponding to the center of the first magnified image 41 or the second magnified image 42. Note that the imaging control unit 32 may control each unit to focus on a focus target determined by the autofocus control on the live view image 40, instead of the center of the first magnified image 41 or the second magnified image 42.

Consequently, by checking the first magnified image 41 or the second magnified image 42, the user can check the position to be focused on, the current degree of focus, and the like on the magnified image.

Then, for example, in a case where the position to be focused on is not at the center of the first magnified image 41 or the second magnified image 42, the user operates the up button 6c, the down button 6d, the right button 6e, and the left button 6f to move the position displayed in magnified view on the first magnified image 41 or the second magnified image 42 in the live view image 40. That is, by moving the image portion displayed on the first magnified image 41 or the second magnified image 42, the user can change the position to be focused on or the like.

On the other hand, in a case where the control target part has not been recognized by the recognition unit 31 in the live view image 40, as shown in FIG. 6(a), the recognition frame 50 is not displayed in the live view image 40.

In this state, when the custom button 6b assigned the execution of the focus magnification display processing is operated, as shown in FIG. 6(b), the display control unit 33 displays the magnification frame 51 superimposed on the live view image 40 to provide a predetermined display magnification with respect to the center of the live view image 40.

Thereafter, when the custom button 6b assigned the execution of the focus magnification display processing or the determination button 6g is operated, as shown in FIG. 6(c), the display control unit 33 causes the display unit 18 to display an image portion indicated by the magnification frame 51 in the live view image 40 as the first magnified image 41. That is, the display control unit 33 causes the display unit 18 to display the first magnified image 41 in which the central portion of the live view image 40 is magnified.

In addition, the display control unit 33 displays the magnification scale icon 52, the image center mark 54, the magnified position display region 55, and the move display icons 56 superimposed on the first magnified image 41.

Furthermore, when the custom button 6b assigned the execution of the focus magnification display processing or the determination button 6g is operated in a state where the first magnified image 41 shown in FIG. 6(c) is displayed on the display unit 18, as shown in FIG. 6(d), the display control unit 33 causes the display unit 18 to display the second magnified image 42 in which a portion of the live view image 40 is further magnified with respect to the center of the first magnified image 41. In addition, the display control unit 33 displays the magnification scale icon 52, the image center mark 54, the magnified position display region 55, and the move display icons 56 superimposed on the second magnified image 42.

Thus, in a case where the control target part has not been recognized, the central portion of the live view image 40 is displayed in magnified view. Then, for example, the up button 6c, the down button 6d, the right button 6e, and the left button 6f are operated to move the position displayed on the first magnified image 41 or the second magnified image 42 in the live view image 40. That is, the user can change the position to be focused on or the like by moving the position of the first magnified image 41 or the second magnified image 42.

As described above, in the focus magnification display processing, a portion (an image portion) of the live view image 40 is displayed in magnified view as the first magnified image 41 or the second magnified image 42. Then, when the shutter button 6a is operated (fully pressed) while the first magnified image 41 or the second magnified image 42 is displayed on the display unit 18, the imaging processing is performed. In the imaging processing, image signals are read from the imaging element 12 and subjected to predetermined image processing, and then image data is recorded on the recording medium. Note that the image recorded as the image data at this time is not the image portion displayed in magnified view on the first magnified image 41 or the second magnified image 42, but the entire image captured by the imaging element 12, corresponding to the live view image 40.

That is, the first magnified image 41 and the second magnified image 42 are displayed in magnified view to allow the user to check a portion of the image to be recorded, and are not magnified to record only that portion.

Note that when the display unit 18 is displaying the live view image 40, a place to be focused on in the live view image 40 may be double-tapped by the user via the touch panel or the like so that the display control unit 33 displays the first magnified image 41 or the second magnified image 42 with the double-tapped image portion at the center.

Furthermore, even in a case where the control target part has not been recognized, if there is a subject in focus, the display control unit 33 may display the first magnified image 41 or the second magnified image 42 with the subject at the center.

### [3-2. Return to Focus Magnification]

When the shutter button 6a is operated (fully pressed) to cause the imaging processing to be performed, the display control unit 33 can selectively control whether or not to continuously display the first magnified image 41 or the second magnified image 42 after the imaging instruction, according to whether return to focus magnification set in advance is on or off.

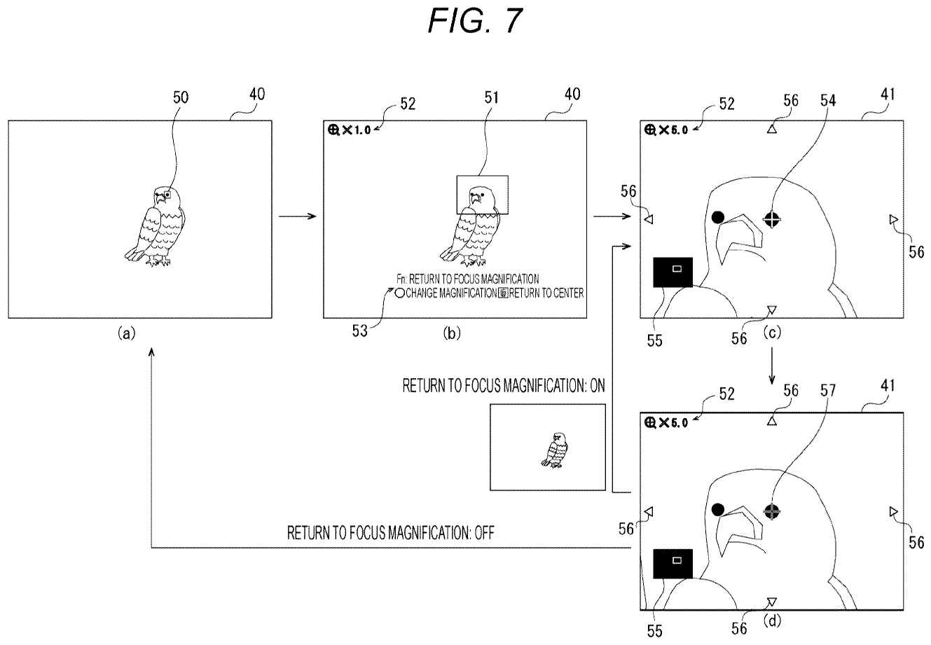

FIG. 7 is a diagram illustrating return to focus magnification. Note that FIGS. 7(a) to 7(c) are the same as FIGS. 5(a) to 5(c), and thus the description thereof will be omitted.

For example, when the shutter button 6a is pressed halfway in a state where the first magnified image 41 is displayed on the display unit 18 as shown in FIG. 7(c), the subject corresponding to the center of the first magnified image 41 is focused on as shown in FIG. 7(d). In addition, the display control unit 33 displays a focus mark 57 indicating that focus is achieved at the position in focus.

Then, when the shutter button 6a is pressed fully, the imaging control unit 32 causes the image focused on the subject corresponding to the center of the first magnified image 41 to be captured and recorded as image data on the recording medium.

Here, return to focus magnification is a function to continuously display the first magnified image 41 or the second magnified image 42 that has been displayed up to that time after the imaging instruction is performed.

Then, in a case where return to focus magnification is on, the first magnified image 41 shown in FIG. 7(c) is continuously displayed on the display unit 18 after the imaging instruction. Note that in a case where the first magnified image 41 is continuously displayed, the display control unit 33 once displays the image (the entire image) to be recorded in the imaging processing on the display unit 18 for a predetermined time, and then displays the first magnified image 41.

Thus, “the first magnified image 41 or the second magnified image 42 is continuously displayed” means that the first magnified image 41 or the second magnified image 42 is displayed on the display unit 18 without user operation. That is, “the first magnified image 41 or the second magnified image 42 is continuously displayed” can be said to cause the display unit 18 to resume the display of the first magnified image 41 or the second magnified image 42 without user operation. The first magnified image 41 or the second magnified image 42 displayed after the imaging instruction is the first magnified image 41 or the second magnified image 42 displayed when the display is resumed.

Therefore, even if another image is inserted when the imaging instruction is performed, such as if the image to be recorded in the imaging processing is temporarily displayed, or if a black image (a mute image) is temporarily displayed during the imaging processing, cases where the first magnified image 41 or the second magnified image 42 is displayed on the display unit 18 without change of the display to the live view image 40 are also included in the continuous display of the first magnified image 41 or the second magnified image 42. Furthermore, in the imaging device 1 in which no so-called blackouts occur during continuous image capturing (continuous shooting), the live view image 40 is temporarily displayed before the first magnified image 41 or the second magnified image 42 is displayed. Such a case is also included in the continuation (resumption) of the first magnified image 41 or the second magnified image 42.

Furthermore, in a case where the first magnified image 41 is continuously displayed, an image portion is displayed which is in the same area as the area of the first magnified image 41 in the live view image 40 displayed before the imaging instruction. That is, if the imaging device 1 and the subject have not moved before and after the imaging processing, the same subject as that before the imaging processing appears in the first magnified image 41 displayed again.

On the other hand, in a case where return to focus magnification is off, the display control unit 33 causes the display unit 18 to display the live view image 40 as shown in FIG. 7(a) instead of the first magnified image 41 or the second magnified image 42 displayed after the imaging instruction. Thus, in a case where return to focus magnification is off, the display control unit 33 completes the focus magnification display processing and displays the live view image 40 on the display unit 18, without resuming the display of the first magnified image 41 or the second magnified image 42 after the imaging instruction.

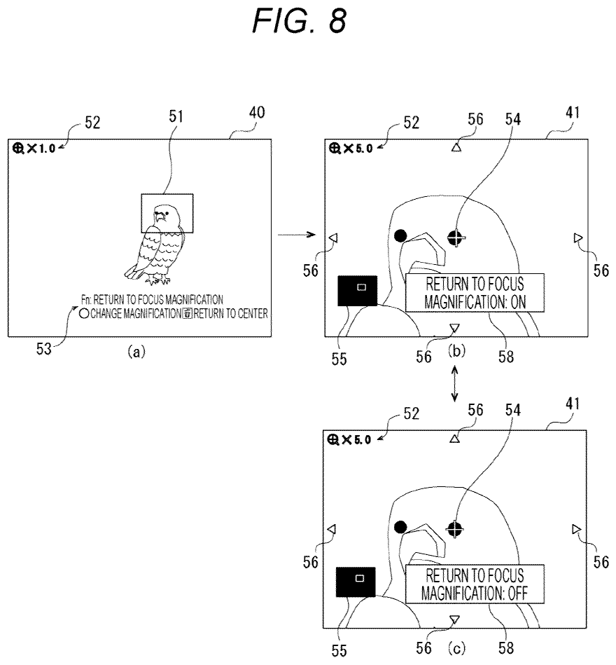

FIG. 8 is a diagram illustrating switching of return to focus magnification between on and off. As shown in FIG. 8(a), the operation guide 53 indicates that return to focus magnification can be switched on and off by operation of the function button 61.

Then, as shown in FIGS. 8(b) and 8(c), when the function button 6i is operated while the first magnified image 41 is displayed on the display unit 18, for example, return to focus magnification is switched on and off.

For example, when the function button 61 is operated when return to focus magnification is off, as shown in FIG. 8(b), the display control unit 33 displays a display switching guide 58 with the description “Return to focus magnification: On” indicating that return to focus magnification has been turned on.

On the other hand, when the function button 61 is operated when return to focus magnification is on, as shown in FIG. 8(c), the display control unit 33 displays the display switching guide 58 with the description “Return to focus magnification: Off” indicating that return to focus magnification has been turned off.

### <3-3. Flow of Focus Magnification Display Processing>

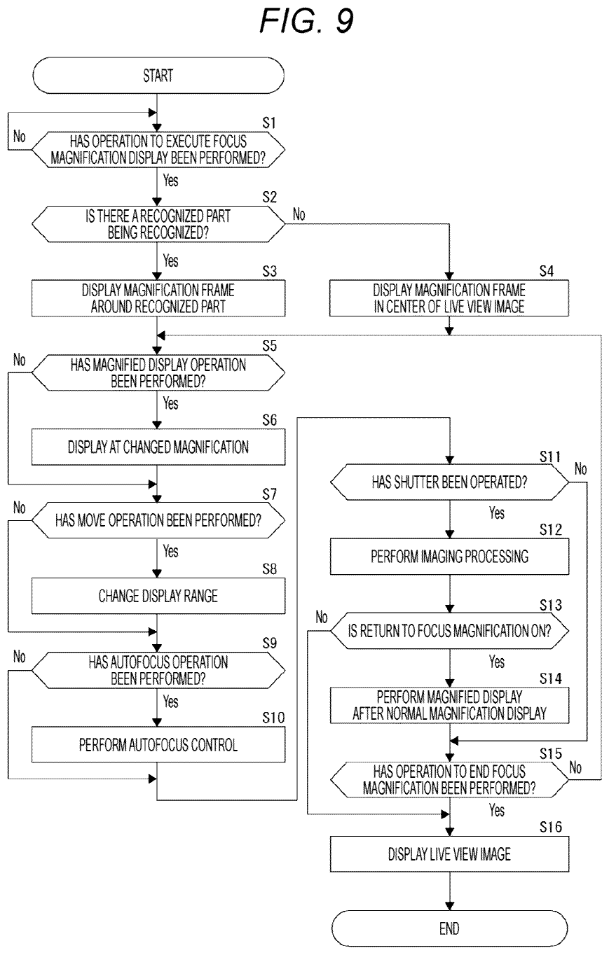

FIG. 9 is a flowchart showing a flow of the focus magnification display processing. As shown in FIG. 9, in step S1, the display control unit 33 determines whether the custom button 6b assigned the execution of the focus magnification display processing has been operated (whether an operation to execute the focus magnification display processing has been performed). Then, step S1 is repeated until the custom button 6b assigned the execution of the focus magnification display processing is operated.

When the custom button 6b assigned the execution of the focus magnification display processing is operated (Yes in step S1), in step S2, the display control unit 33 determines whether there is a control target part (a subject) that has been recognized by the recognition unit 31 in the live view image 40. As a result, in a case where there is a recognized control target part (Yes in step S2), in step S3, the display control unit 33 displays the magnification frame 51 centered on the recognized control target part, superimposed on the live view image 40. On the other hand, in a case where there is no recognized control target part (No in step S2), in step 4, the display control unit 33 displays the magnification frame 51 with respect to the center of the live view image 40.

In step S5, the display control unit 33 determines whether the custom button 6b assigned the execution of the focus magnification display processing or the determination button 6g has been operated, that is, whether an operation for magnified display has been performed. As a result, in a case where the operation for magnified display has not been performed (No in step S5), the process proceeds to step S7, skipping step S6.

On the other hand, in a case where the operation for magnified display has been performed (Yes in step S5), in step S6, the display control unit 33 displays the first magnified image 41 when the live view image 40 is displayed, and displays the second magnified image 42 when the first magnified image 41 is displayed.

In step S7, the display control unit 33 determines whether the up button 6c, the down button 6d, the right button 6e, and the left button 6f have been operated, that is, whether an operation to move the image portion to be displayed in magnified view has been performed. As a result, in a case where the operation to move the image portion to be displayed in magnified view has not been performed (No in step S7), the process proceeds to step S9, skipping step S8.

On the other hand, in a case where the operation to move the portion to be displayed in magnified view has been performed (Yes in step S7), in step S8, the display control unit 33 moves the image portion of the live view image 40 to be displayed in magnified view, according to the operation of the up button 6c, the down button 6d, the right button 6e, and the left button 6f, to display the first magnified image 41 or the second magnified image 42.

In step 99, the imaging control unit 32 determines whether an operation to perform autofocus, such as pressing the shutter button 6a halfway, has been performed. As a result, in a case where the operation to perform autofocus has not been performed (No in step S9). The process proceeds to step S11, skipping step S10.

On the other hand, in a case where the operation to perform autofocus has been performed (Yes in step S9), in step 10, the imaging control unit 32 performs the autofocus control to focus on a predetermined subject. For example, the display control unit 33 focuses on the center of the first magnified image 41 or the second magnified image 42, or focuses on the recognized control target part.

In step S11, the imaging control unit 32 determines whether an operation of the imaging instruction for performing the imaging processing, such as pressing the shutter button 6a fully, has been performed. As a result, in a case where the operation for performing the imaging processing has not been performed (No in step S11), the process proceeds to step S15, skipping processing in steps S12 to S14.

On the other hand, in a case where the operation for performing the imaging processing has been performed (Yes in step S11), in step S12, the imaging control unit 32 controls each unit to perform the imaging processing to record image data on the recording medium.

In step S13, the display control unit 33 determines whether return to focus magnification is on. As a result, when return to focus magnification is not on, that is, when return to focus magnification is off (No in step S13), the process proceeds to step S16, skipping steps S14 and S15.

On the other hand, in a case where return to focus magnification is on (Yes in step S13), in step S14, the display control unit 33 causes the display unit 18 to display the image to be stored on the storage medium in the imaging processing, and then causes the display unit 18 to continuously display the first magnified image 41 or the second magnified image 42 in a manner similar to that before the imaging instruction.

In step S15, the display control unit 33 determines whether a predetermined operation to end the focus magnification display processing has been performed. Then, in a case where the operation to end the focus magnification display processing has not been performed (No in step S15), the process returns to step S5.

On the other hand, in a case where return to focus magnification is off (No in step S13), and in a case where the operation to end the focus magnification display processing has been performed (Yes in step S15), in step S16, the display control unit 33 causes the display unit 18 to display the live view image 40.

### 4. Modifications

Note that the embodiment is not limited to the specific examples described above and may adopt various configurations as modifications.

For example, in the above-described embodiment, the first magnified image 41 and the second magnified image 42 are provided as magnified images. However, a magnified image may be only one of the first magnified image 41 and the second magnified image 42, or magnified images at three or more different magnifications may be provided.

In the above-described embodiment, when the shutter button 6a is pressed halfway while the first magnified image 41 or the second magnified image 42 is displayed on the display unit 18, the focus is adjusted to the center of the first magnified image 41 or the second magnified image 42.

However, for example, in a case where the control target part (the subject) has been recognized by the recognition unit 31, when the shutter button 6a is pressed halfway while the first magnified image 41 or the second magnified image 42 is displayed on the display unit 18, the focus may be adjusted to the recognized control target part.

Furthermore, in the above-described embodiment, in a case where return to focus magnification is on, and the first magnified image 41 or the second magnified image 42 is displayed after the imaging instruction, an image portion in the same area as the area in the live view image 40 displayed before the imaging instruction is displayed in magnified view.

However, in a case where the control target part (the subject) has been recognized by the recognition unit 31, the display control unit 33 may display the first magnified image 41 or the second magnified image 42 centered on the subject that has been recognized by the recognition unit 31 (the recognized control target part of the recognizable parts according to the subject category) after the imaging instruction.

That is, the first magnified image 41 or the second magnified image 42 may be displayed such that the control target part tracked by the recognition unit 31 appears in the center.

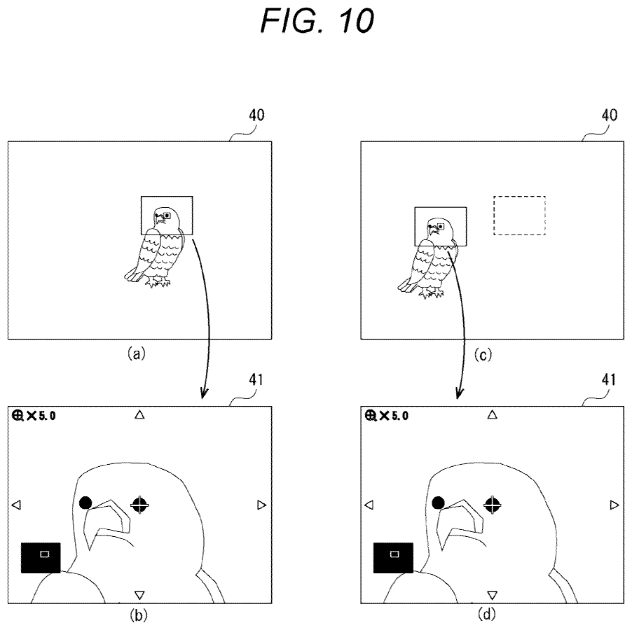

Specifically, as shown in FIGS. 10(a) and 10(b), assume that the control target part (here, the left eye of the bird) has been recognized by the recognition unit 31, and the first magnified image 41 centered on the control target part is displayed on the display unit 18. In this case, even if the imaging instruction is performed and the bird moves as shown in FIG. 10(c) after the imaging instruction, if the recognition unit 31 continues to recognize the control target part, as shown in FIG. 10(d), the display control unit 33 moves the image portion to be displayed in magnified view to display the first magnified image 41 centered on the control target part on the display unit 18.

Thus, the imaging device 1 can perform magnified display following the control target part.

Further, in a case where return to focus magnification is on, the display control unit 33 may display the first magnified image 41 or the second magnified image 42 centered on an image portion that is centered on a subject in focus after the imaging instruction.

Furthermore, in a case where return to focus magnification is on, after the imaging instruction, the display control unit 33 may display an image portion in the same area as the area in the live view image 40 displayed before the imaging instruction, or the subject (the control target part) that has been recognized by the recognition unit 31 in the live view image 40, as the magnified image on the basis of a predetermined condition.

Note that as the predetermined condition, various conditions are possible. For example, the first magnified image 41 or the second magnified image 42 is displayed on the basis of a condition set by the user.

Furthermore, in the above-described embodiment, whether to display the live view image 40 or display the first magnified image 41 or the second magnified image 42 after the imaging instruction is determined according to whether return to focus magnification is on or off.

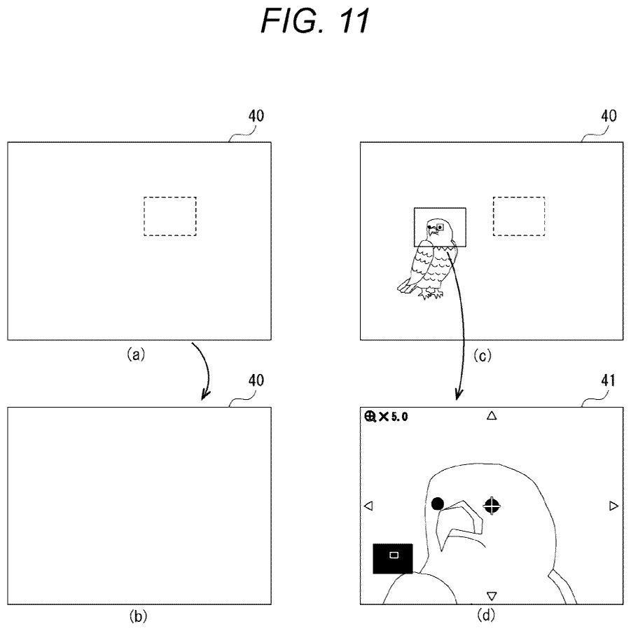

However, for example, as shown in FIGS. 11(a) and 11(b), when the subject (the control target part) goes out of the live view image 40 after the imaging instruction, the display control unit 33 causes the display unit 18 to display the live view image 40 instead of the magnified image (the first magnified image 41 or the second magnified image 42). On the other hand, as shown in FIGS. 11(c) and 11(d), when the subject (the control target part) is in the live view image 40, the display control unit 33 may cause the display unit 18 to display the magnified image (the first magnified image 41) centered on the subject.

Furthermore, for example, in a case where a plurality of modes is provided, such as a sports mode optimal for capturing sports scenes and a landscape mode optimal for capturing landscapes, the display control unit 33 may determine whether or not to continuously display the magnified image after the imaging instruction, according to a set mode.

Furthermore, the display control unit 33 may determine whether or not to continuously display the magnified image after the imaging instruction, according to the motion of the subject.

For example, in a case where the subject wiggles, it is necessary to adjust the focus for each movement. Thus, display of the magnified image facilitates the focusing. Furthermore, in a case where the subject hardly moves like a landscape, it is not necessary to adjust the focus again. Thus, the display of the live view image 40 allows the whole to be checked.

### 5. Summary

According to the imaging device 1 of the above embodiment, the following effects can be obtained.

The imaging device 1 of the embodiment includes the display control unit 33 that causes the display unit 18 to continuously display the magnified image (the first magnified image 41 or the second magnified image 42) that is a magnified portion of the live view image 40 based on the input image, after the imaging instruction during the display of the magnified image by the display unit 18.

Consequently, for example, in a case where it is desired to continuously record images, even if the imaging instruction is performed while the magnified image is displayed, the imaging device 1 can continue to display the magnified image, allowing the user to check an image portion of the live view image displayed in magnified view as needed.

Therefore, it is possible to allow the user to check the live view image displayed in magnified view without forcing a complicated operation.

Furthermore, the display control unit 33 causes the display unit 18 to resume display of the magnified image (the first magnified image 41 or the second magnified image 42) after the imaging instruction.

Consequently, the imaging device 1 allows the user to check the live view image displayed in magnified view without forcing a complicated operation.

Furthermore, the display control unit 33 can selectively control whether or not to continuously display the magnified image (the first magnified image 41 or the second magnified image 42) after the imaging instruction.

Consequently, the imaging device 1 can cause the display unit 18 to display either the live view image 40 or the magnified image after the imaging instruction, according to the user's preference or use status.

Furthermore, the imaging device 1 includes the recognition unit 31 that recognizes the subject (the control target part) on the basis of the input image. The display control unit 33 causes the display unit 18 to display an image portion centered on the subject recognized by the recognition unit 31 in the live view image 40 as the magnified image (the first magnified image 41 or the second magnified image 42).

Consequently, the imaging device 1 allows the user to easily check the subject to be focused on by autofocus, for example.

The display control unit 33 determines a region of the subject to be displayed as the magnified image (the first magnified image 41 or the second magnified image 42) according to the subject category.

This allows the determination of an optimal region to be magnified according to the subject category.

The display control unit 33 causes the display unit 18 to display, as the magnified image, an image portion centered on the recognized control target part of the recognizable parts according to the category of the subject.

This allows one part of the recognizable parts considered to be optimal according to the subject category to be magnified to be checked by the user.

The control target part is selected by the user from the recognizable parts.

This allows the part desired by the user to be magnified to be checked by the user.

The display control unit 33 causes the display unit 18 to display an image portion centered on a subject in focus as the magnified image (the first magnified image 41 or the second magnified image 42).

Consequently, the imaging device 1 allows the user to easily check the subject to be focused on by autofocus, for example.

The display control unit 33 causes the display unit 18 to display an image portion in the same area as the area of the magnified image in the live view image 40 displayed at the time of the imaging instruction as the magnified image (the first magnified image 41 or the second magnified image 42) to be displayed after the imaging instruction.

Consequently, the imaging device 1 allows the user to check the same area in the live view image 40 as the magnified image before and after the imaging instruction when continuously capturing images, for example.

The display control unit 33 causes the display unit 18 to display an image portion centered on the subject (the control target part) that has been recognized by the recognition unit 31 in the live view image 40 as the magnified image (the first magnified image 41 or the second magnified image 42) to be displayed after the imaging instruction.

Consequently, the imaging device 1 allows the user to check the image portion in which the subject that has been recognized by the recognition unit 31 appears in the magnified image before and after the imaging processing when continuously capturing images of the same subject, for example.

The display control unit 33 determines the region of the subject to be displayed as the magnified image (the first magnified image 41 or the second magnified image 42) to be displayed after the imaging instruction, according to the category of the subject.

This allows the determination of the optimum magnified region according to the subject category.

The display control unit 33 causes the display unit 18 to display an image portion centered on the recognized control target part of the recognizable parts according to the category of the subject as the magnified image (the first magnified image 41 or the second magnified image 42) to be displayed after the imaging instruction.

This allows one part of the recognizable parts considered to be optimal according to the subject category to be magnified to be checked by the user.

The control target part is selected by the user from the recognizable parts.

This allows the part desired by the user to be magnified to be checked by the user.

The display control unit 33 causes the display unit 18 to display an image portion centered on a subject in focus as the magnified image to be displayed after the imaging instruction.

Consequently, the imaging device 1 allows the user to easily check the subject to be focused on by autofocus, for example.

The display control unit 33 causes the display unit 18 to display an image portion in the same area as the area of the magnified image in the live view image 40 displayed at the time of the imaging instruction, or centered on the subject that has been recognized by the recognition unit 31 in the live view image 40, as the magnified image to be displayed after the imaging instruction according to the predetermined condition.

Consequently, the imaging device 1 can display the original position or the subject as the magnified image after the imaging processing, according to the user's preference or use status.

The display control unit 33 causes the display unit 18 to display the live view image 40 instead of the magnified image to be displayed after the imaging instruction when the subject goes out of the live view image 40, and causes the display unit 18 to display an image portion centered on the subject as the magnified image (the first magnified image 41 or the second magnified image 42) to be displayed after the imaging instruction when the subject is in the live view image 40.

Consequently, when the subject goes out of the live view image 40, the imaging device 1 can avoid the subject from not being shown even when the magnified image is displayed, and an additional operation from being performed instead, such as moving the image portion displayed on the magnified image to search for the subject.

The display control unit 33 determines whether or not to continuously display the magnified image (the first magnified image 41 or the second magnified image 42) after the imaging instruction, according to the motion of the subject.

Consequently, for example, in a case where the subject wiggles and thus the focus is adjusted for each movement, the imaging device 1 displays the subject in magnified view to facilitate the focusing. Furthermore, in a case where the subject hardly moves like a landscape, the imaging device 1 does not need to adjust the focus again, and thus displays the live view image 40 to allow the whole to be checked.

As described above, by displaying the live view image 40 or the magnified image according to the motion of the subject, the user is allowed to check a more appropriate image.

In a case where the imaging instruction is performed according to a set mode, the display control unit 33 determines, according to the set mode, whether or not to change the display from the magnified image (the first magnified image 41 or second magnified image 42) to the live view image 40, or continuously display the magnified image after the imaging instruction.

Consequently, the imaging device 1 can optimally display the live view image or the magnified image according to the mode.

An imaging control method causes the display unit 18 to continuously display the magnified image (the first magnified image 41 or the second magnified image 42) that is a magnified portion of the live view image 40 based on the input image, after the imaging instruction during the display of the magnified image by the display unit 18.

Furthermore, a program causes a computer to perform processing of causing the display unit 18 to continuously display the magnified image (the first magnified image 41 or the second magnified image 42) that is a magnified portion of the live view image 40 based on the input image, after the imaging instruction during the display of the magnified image by the display unit 18.

The program of the embodiment is, for example, a program causing a processor such as a CPU or a DSP, or a device including them to execute the above-described image processing.

Such a program can be recorded in advance on an HDD as a recording medium built in a device such as a computer device, a ROM in a microcomputer including a CPU, or the like. Furthermore, such a program can be temporarily or permanently stored (recorded) on a removable recording medium such as a flexible disk, a compact disc read-only memory (CD-ROM), a magneto optical (MO) disk, a digital versatile disc (DVD), a Blu-ray Disc (registered trademark), a magnetic disk, a semiconductor memory, or a memory card. Such a removable recording medium can be provided as so-called package software.

Furthermore, such a program may be installed from a removable recording medium into a personal computer or the like, or may be downloaded from a download site through a network such as a local area network (LAN) or the Internet.

Note that the effects described in the present description are merely examples and are not limited, and other effects may be provided.

### 6. Present Technology

Note that the present technology can also adopt the following configurations.

(1)

An imaging device including
a display control unit that causes a display unit to continuously display a magnified image that is a magnified portion of a live view image based on an input image, after an imaging instruction during display of the magnified image by the display unit.
   (2)

The imaging device according to (1),
in which the display control unit causes the display unit to resume display of the magnified image after the imaging instruction.
   (3)

The imaging device according to (1) or (2),
in which the display control unit can selectively control whether or not to continuously display the magnified image after the imaging instruction.
   (4)

The imaging device according to any one of (1) to (3), further including
a recognition unit that recognizes a subject on the basis of the input image,
in which the display control unit causes the display unit to display, as the magnified image, an image portion centered on the subject that has been recognized by the recognition unit in the live view image.
   (5)

The imaging device according to (4),
in which the display control unit determines a region of the subject to be displayed as the magnified image according to the category of the subject.
   (6)

The imaging device according to (5),
in which the display control unit causes the display unit to display, as the magnified image, an image portion centered on a recognized control target part of recognizable parts according to the category of the subject.
   (7)

The imaging device according to (6),
in which the control target part is selected by a user from the recognizable parts.
   (8) The imaging device according to any one of (1) to (3),
in which the display control unit causes the display unit to display, as the magnified image, an image portion centered on a subject in focus.
   (9)

The imaging device according to any one of (1) to (8),
in which the display control unit causes the display unit to display an image portion in the same area as the area of the magnified image in the live view image displayed at the time of the imaging instruction as the magnified image to be displayed after the imaging instruction.
   (10)

The imaging device according to (4),
in which the display control unit causes the display unit to display the image portion centered on the subject that has been recognized by the recognition unit in the live view image as the magnified image to be displayed after the imaging instruction.
   (11)

The imaging device according to (10),
in which the display control unit determines a region of the subject to be displayed as the magnified image to be displayed after the imaging instruction, according to the category of the subject.
   (12)

The imaging device according to (11),
in which the display control unit causes the display unit to display an image portion centered on a recognized control target part of recognizable parts according to the category of the subject as the magnified image to be displayed after the imaging instruction.
   (13)

The imaging device according to (12),
in which the control target part is selected by a user from the recognizable parts.
   (14)

The imaging device according to any one of (1) to (3),
in which the display control unit causes the display unit to display an image portion centered on a subject in focus as the magnified image to be displayed after the imaging instruction.
   (15)

The imaging device according to any one of (3) to (8) and (10) to (14),
in which the display control unit causes the display unit to display an image portion in the same area as the area of the magnified image in the live view image displayed at the time of the imaging instruction, or the image portion centered on the subject that has been recognized by the recognition unit in the live view image, as the magnified image to be displayed after the imaging instruction according to a predetermined condition.
   (16)

The imaging device according to any one of (3) to (15),
in which the display control unit causes the display unit to display the live view image instead of the magnified image to be displayed after the imaging instruction when a subject goes out of the live view image, and causes the display unit to display an image portion centered on the subject as the magnified image to be displayed after the imaging instruction when the subject is in the live view image.
   (17)

The imaging device according to any one of (3) to (16),
in which the display control unit determines whether or not to continuously display the magnified image after the imaging instruction according to the motion of a subject.
   (18)

The imaging device according to any one of (3) to (17),
in which in a case where the imaging instruction is performed according to a set mode, the display control unit determines whether or not to change display from the magnified image to the live view image according to the mode, or continuously display the magnified image after the imaging instruction, according to the set mode.
   (19)

An imaging control method including
causing a display unit to continuously display a magnified image that is a magnified portion of a live view image based on an input image, after an imaging instruction during display of the magnified image by the display unit.
   (20)

A program causing a computer to perform processing of
causing a display unit to continuously display a magnified image that is a magnified portion of a live view image based on an input image, after an imaging instruction during display of the magnified image by the display unit.

### REFERENCE SIGNS LIST

1 Imaging device
6 Manipulation element
21 Camera control unit
31 Recognition unit
32 Imaging control unit
33 Display control unit

1. An imaging device comprising
a display control unit that causes a display unit to continuously display a magnified image that is a magnified portion of a live view image based on an input image, after an imaging instruction during display of the magnified image by the display unit.

2. The imaging device according to claim 1,
wherein the display control unit causes the display unit to resume display of the magnified image after the imaging instruction.

3. The imaging device according to claim 1,
wherein the display control unit can selectively control whether or not to continuously display the magnified image after the imaging instruction.

4. The imaging device according to claim 1, further comprising
a recognition unit that recognizes a subject on a basis of the input image,
wherein the display control unit causes the display unit to display, as the magnified image, an image portion centered on the subject that has been recognized by the recognition unit in the live view image.

5. The imaging device according to claim 4,
wherein the display control unit determines a region of the subject to be displayed as the magnified image according to a category of the subject.

6. The imaging device according to claim 5,
wherein the display control unit causes the display unit to display, as the magnified image, an image portion centered on a recognized control target part of recognizable parts according to the category of the subject.

7. The imaging device according to claim 6,
wherein the control target part is selected by a user from the recognizable parts.

8. The imaging device according to claim 1,
wherein the display control unit causes the display unit to display, as the magnified image, an image portion centered on a subject in focus.

9. The imaging device according to claim 1,
wherein the display control unit causes the display unit to display an image portion in the same area as an area of the magnified image in the live view image displayed at a time of the imaging instruction as the magnified image to be displayed after the imaging instruction.

10. The imaging device according to claim 4,
wherein the display control unit causes the display unit to display the image portion centered on the subject that has been recognized by the recognition unit in the live view image as the magnified image to be displayed after the imaging instruction.

11. The imaging device according to claim 10,
wherein the display control unit determines a region of the subject to be displayed as the magnified image to be displayed after the imaging instruction, according to a category of the subject.

12. The imaging device according to claim 11,
wherein the display control unit causes the display unit to display an image portion centered on a recognized control target part of recognizable parts according to the category of the subject as the magnified image to be displayed after the imaging instruction.

13. The imaging device according to claim 12,
wherein the control target part is selected by a user from the recognizable parts.

14. The imaging device according to claim 1,
wherein the display control unit causes the display unit to display an image portion centered on a subject in focus as the magnified image to be displayed after the imaging instruction.

15. The imaging device according to claim 4,
wherein the display control unit causes the display unit to display an image portion in the same area as an area of the magnified image in the live view image displayed at a time of the imaging instruction, or the image portion centered on the subject that has been recognized by the recognition unit in the live view image, as the magnified image to be displayed after the imaging instruction according to a predetermined condition.

16. The imaging device according to claim 3,
wherein the display control unit causes the display unit to display the live view image instead of the magnified image to be displayed after the imaging instruction when a subject goes out of the live view image, and causes the display unit to display an image portion centered on the subject as the magnified image to be displayed after the imaging instruction when the subject is in the live view image.

17. The imaging device according to claim 3,
wherein the display control unit determines whether or not to continuously display the magnified image after the imaging instruction according to a motion of a subject.

18. The imaging device according to claim 3,
wherein in a case where the imaging instruction is performed according to a set mode, the display control unit determines whether or not to change display from the magnified image to the live view image according to the mode, or continuously display the magnified image after the imaging instruction, according to the set mode.

19. An imaging control method comprising
causing a display unit to continuously display a magnified image that is a magnified portion of a live view image based on an input image, after an imaging instruction during display of the magnified image by the display unit.

20. A program causing a computer to perform processing of
causing a display unit to continuously display a magnified image that is a magnified portion of a live view image based on an input image, after an imaging instruction during display of the magnified image by the display unit.
